(19) United States
(12) Patent Application Publication
(10) Pub. No.: US 2022/0304506 A1
(43) Pub. Date: Sep. 29, 2022

(54) MODULAR OUTDOOR GRILL

(71) Applicants: BSH Home Appliances Corporation, Irvine, CA (US); BSH Hausgeräte GmbH, Munich (DE)

(72) Inventors: Christoph Bauerdick, Aveiro (DE); Fabian Kollmann, Stuttgart (DE); Martin Nussbaum, Kirchheim (DE); Martin Kroeger, Stuttgart (DE)

(21) Appl. No.: 17/210,553

(22) Filed: Mar. 24, 2021

(51) Int. Cl. A47J 37/07; A47J 36/32; F24C 15/18; F24C 15/08

(52) U.S. Cl. CPC A47J 37/0713; A47J 37/0786; A47J 36/32; F24C 15/18; F24C 15/08; A47J 2201/00

(57) ABSTRACT

Modular outdoor grills may include a grill housing and grill lid collectively enclosing one or more burners. In some examples, work surfaces or shelves coupled to the grill housing may be removable and/or pivotable. In some examples, the grill may be powered by both a battery and propane fuel. In some examples, the grill is controllable using a mobile digital device.

### FIELD

This disclosure relates to systems and methods for outdoor cooking systems. More specifically, the disclosed embodiments relate to propane grills.

### INTRODUCTION

Outdoor grills generally feature a grill housing and a plurality of burners. Generally, the burners are controllable by a plurality of knobs which vary a propane flow within the grill, but which provide minimal amount of temperature control. Additionally, users often must closely supervise grills to produce evenly cooked food. Outdoor grills often feature fixed workspaces, which may take up space and be hard to clean.

### SUMMARY

The present disclosure provides systems, apparatuses, and methods relating to gas grills having various convenience features and enhanced functionality.

An outdoor grill in accordance with aspects of the present disclosure may include: a grilling surface disposed above a burner in a grill housing; a fuel supply system coupled to the burner and configured to convey fuel to the burner from a replaceable fuel tank; a support base coupled to the grill housing and structurally supporting the grill housing at a working height; and a shelf having a peripheral hoop extending at least partly around the shelf, such that the hoop is removably coupled to a hook adjacent the grilling surface, wherein the hook comprises an elongate, vertically oriented lip, such that the shelf is configured to be selectively attached and detached from the grill.

An outdoor grill in accordance with aspects of the present disclosure may include: a grilling surface disposed above a burner in a grill housing; a fuel supply system coupled to the burner and configured to convey fuel to the burner from a replaceable fuel tank; a support base coupled to the grill housing and structurally supporting the grill housing at a working height; and a shelf pivotably coupled to the grill such that the shelf is pivotable about a vertical axis between a plurality of positions relative to the grill housing.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a view of a first illustrative grill in accordance with aspects of the present disclosure.

FIG. 2 is a view of an illustrative propane tank and battery housing suitable for use with the grill of FIG. 1, in accordance with aspects of the present disclosure.

FIG. 3 is an exploded view of portions of the illustrative propane tank and battery housing of FIG. 2.

FIG. 4 is a view of an illustrative fuel line suitable for use with the illustrative propane tank and battery housing of FIG. 2.

FIG. 5 is a view of an illustrative sliding grill lid of the grill of FIG. 1, depicted in an open configuration.

FIG. 6 is a front view of the sliding grill lid of FIG. 5, depicted in a closed configuration.

FIG. 7 is a view of an illustrative modular cutting surface of the grill of FIG. 1, depicted in a disengaged configuration.

FIG. 8 is a front isometric view of heating and cooling drawers of the grill of FIG. 1.

FIG. 9 is a view of a second illustrative grill in accordance with aspects of the present disclosure.

FIG. 10 is a view of the grill of FIG. 9, with a hibachi portion depicted in a disengaged configuration.

FIG. 11 is a view of the grill of FIG. 9, depicting cutting surfaces of the grill in a variety of positions.

FIG. 12 is a partial isometric view of the grill of FIG. 9, depicting a visual indicator light.

FIG. 13 is a schematic diagram of an illustrative data processing system as described herein.

FIG. 14 is a schematic diagram of an illustrative network data processing system as described herein.

### DETAILED DESCRIPTION

Various aspects and examples of a modular outdoor grill, as well as related methods, are described below and illustrated in the associated drawings. Unless otherwise specified, a modular outdoor grill in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Rigid” describes a material or structure configured to be stiff, non-deformable, or substantially lacking in flexibility under normal operating conditions.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

Overview In general, a modular grill in accordance with the present teachings may include a grill housing, at least one burner disposed within the grill housing, and a grill lid which collectively encloses the at least one burner when paired with the grill housing. The burner is coupled to a fuel (e.g., propane) tank by a fuel line, and may include one or more electrodes. In some examples, the grill housing includes a compartment configured to house the propane tank while the grill is in use. In some examples, the compartment includes a recess further configured to house a battery. In some examples, a burner portion of the grill housing is separable from the propane tank compartment, such that the burner portion of the housing may be operable separately, in conjunction with an auxiliary propane tank. The grill may include a plurality of control mechanisms such as switches, knobs, buttons, and/or the like which allow a user to perform functions such as adjusting a grill temperature, igniting the grill, and/or the like.

In some examples, the grill includes one or more modular work surfaces, which may be moved (e.g., pivoted, transitioned, etc.) between one or more positions relative to and adjacent to the grill housing. In some examples, the modular work surfaces are releasably coupled to the grill housing (e.g., using releasable fasteners, male-female couplings, etc.) In some examples, the grill includes one or more propane-powered temperature-controlled drawers, which may cool or warm food and/or ingredients.

In some examples, the grill includes one or more controllers which may be configured to automate certain functions of the grill. The controllers may couple to a distributed computing system, e.g., over the Internet, which may enable remote monitoring and control of grill function. In some examples, the modular grill includes an associated software application (app) or other program which enables a user to control the grill using one or more devices such as a cell phone, tablet, smart-home system, and/or the like. In some examples, the grill includes a sensor coupled to the propane tank, which, when coupled to a portable device by the one or more controllers, allow a user to remotely monitor a fuel level of the propane tank. In some examples, the grill includes a battery and one or more battery-powered components, and may allow a user to remotely monitor a charge level of the battery. In some examples, the grill includes one or more smart components, which may cook food to a desired doneness level based on data collected from a variety of sensors disposed within the grill housing. In some examples, the grill includes an auto clean function, which is remotely controllable by a user. In some examples, the grill includes one or more visual indicators (e.g., lights) disposed on an external surface of the grill housing, which utilize data collected from temperature sensors to indicate a grill temperature.

Aspects of modular grills (e.g., a controller thereof) may be embodied as a computer method, computer system, or computer program product. Accordingly, aspects of the modular grill may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the modular grill may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of modular grills and associated programs may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTMLS, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the modular grill and associated programs may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the modular outdoor grill. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative modular outdoor grills as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. First Illustrative Modular Grill

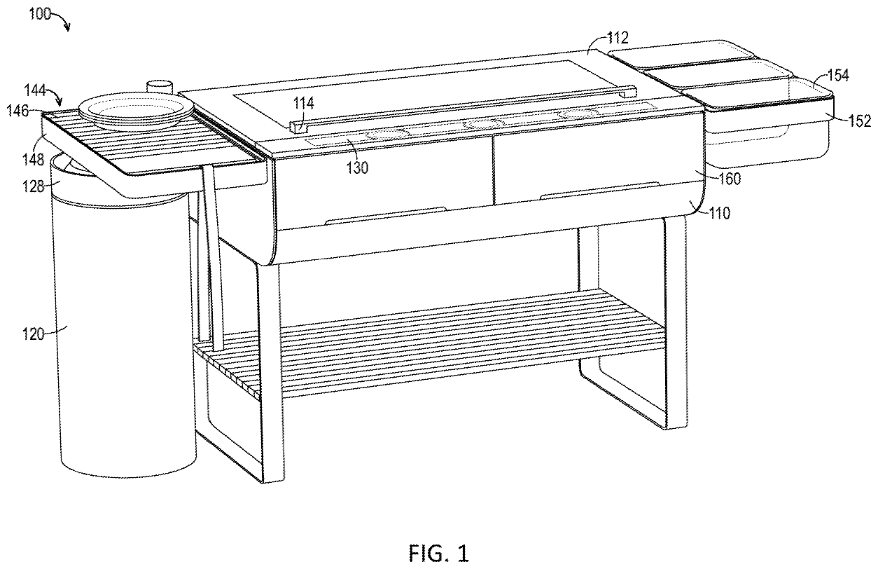

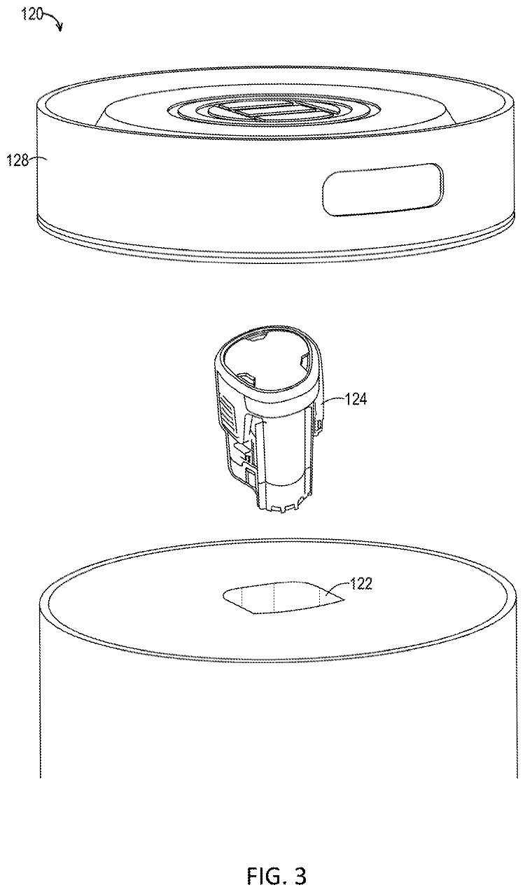

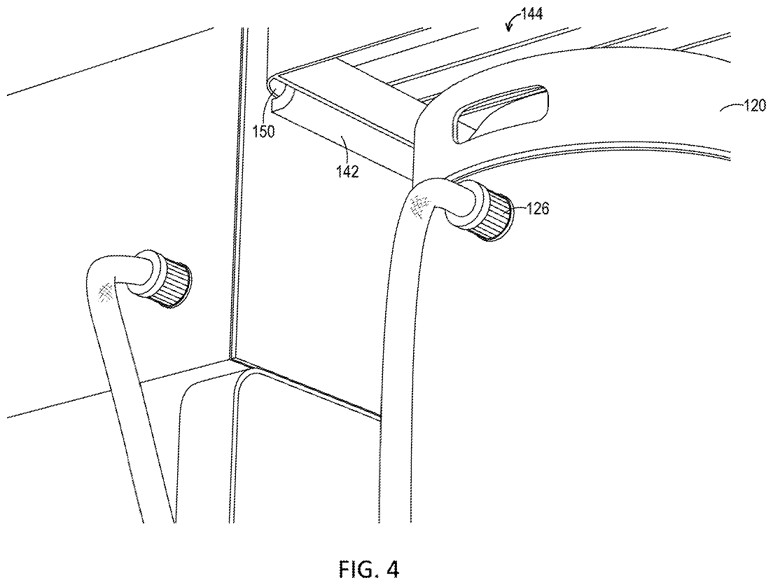

As shown in FIGS. 1-8, this section describes an illustrative modular outdoor grill 100, which includes a grill housing 110 having at least one burner and a grill opening, and a grill lid 112 which selectively opens and closes the grill opening. In some examples, the grill housing further includes a support base coupled to a bottom of the grill housing and structurally supporting the grill housing at a working height. In some examples, the grill housing is selectively removable from the support base. Grill housing 110 comprises any suitable material configured to withstand high temperatures, such as metals, coated metals, ceramics, and/or the like. In some examples, grill housing 110 includes a grate 115 defining a substantially rectangular cooking surface (AKA grilling surface) 118 disposed above the burner, toward or through which flame produced by the burner may extend. In some examples, the at least one burner includes one or more electrodes configured to ignite a flow of propane through the burner.

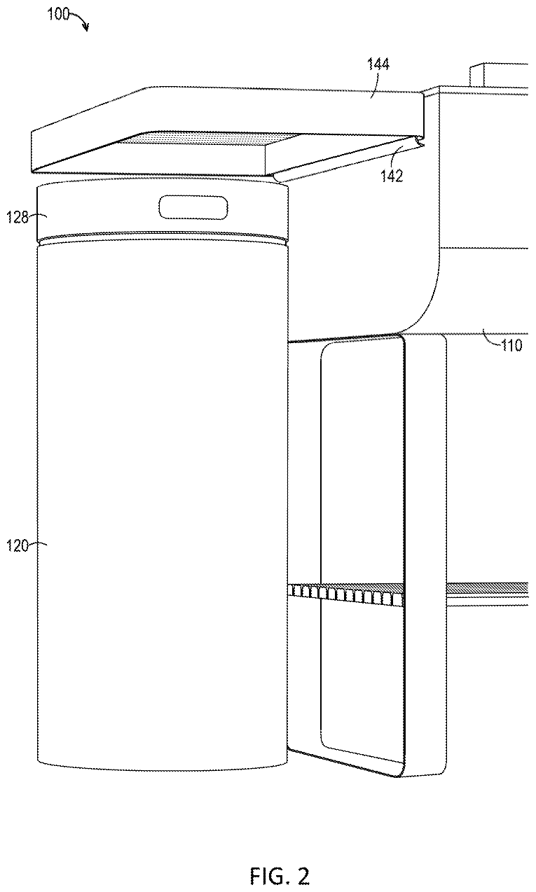

Turning now to FIGS. 2-4, an illustrative propane compartment 120 is depicted. Propane compartment 120 is configured to sit beside and/or be coupled to grill housing 110. In some examples, propane compartment 120 is a common enclosure for a replaceable fuel tank and a battery. In some examples, propane compartment 120 comprises a heat resistant and/or insulated material, such as such as metals, coated metals, ceramics, and/or the like. Propane compartment 120 includes a housing (e.g., a cylindrical housing), which may be open at a bottom surface to accept a replaceable fuel tank (e.g., a propane tank). In some examples, propane compartment 120 includes a receptacle or recess 122, which is configured to hold a rechargeable battery 124 (e.g., lithium-ion battery, power tool battery) which provides electrical power to one or more electrical features of grill 100. In some examples, propane compartment 120 includes a lid 128 which seals the battery within the recess.

Propane compartment 120 includes a hybrid fuel/power line (AKA fuel supply system) 126, which conveys both propane fuel and electrical current between the propane compartment and the one or more burners. Fuel line 126 may include any suitable connection mechanism for a gas line disposed at both ends, such as quick-connect fittings, screw fittings, and/or the like. In some examples, ends of fuel line 126 may include valves configured to seal ends of the fuel line while the fuel line is disconnected. In some examples, fuel/power line 126 includes an electrical cable or other conductor disposed in an insulated enclosure coupled to or enclosed by the propane line.

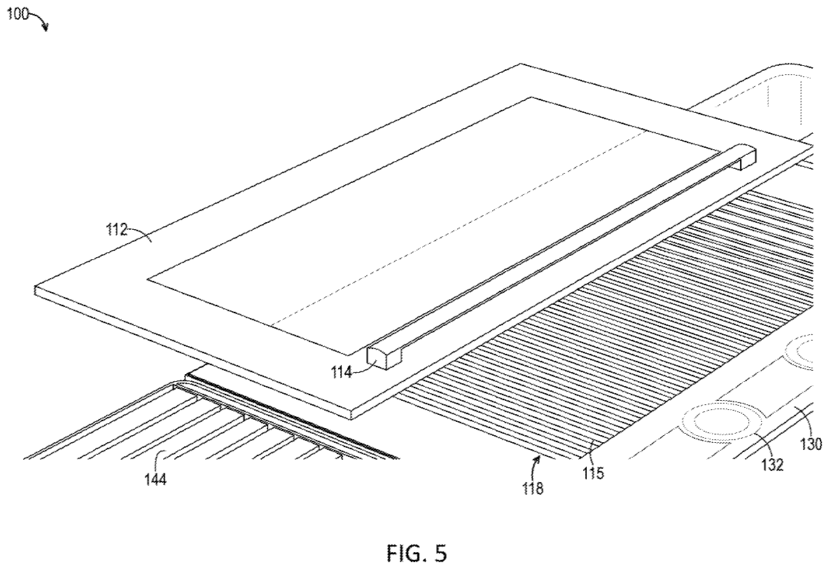

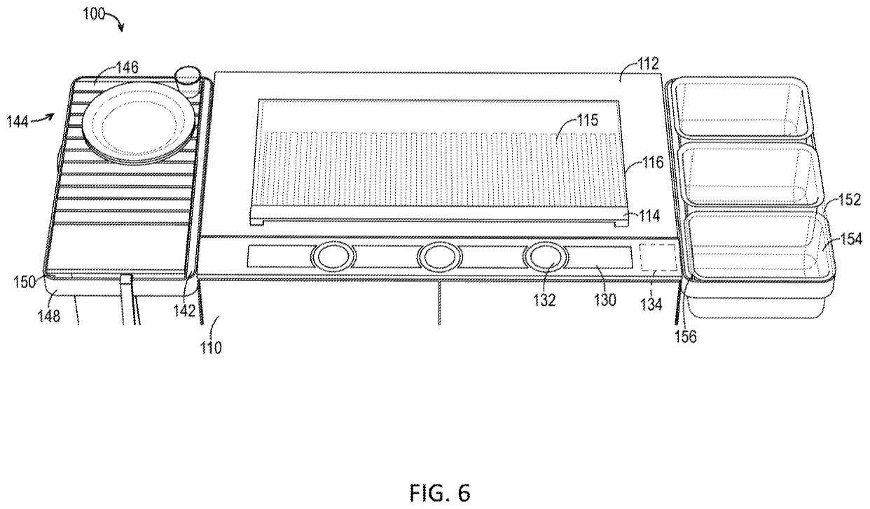

In some examples, grill lid 112 comprises a planar rectangle, which is configured to translate or slide between an open configuration (See FIG. 5) and a closed configuration (See FIG. 6) along the cooking surface. In some examples, grill lid 112 includes a handle 114, e.g., disposed along a front edge of the grill lid, and includes a viewing window 116 disposed in the grill lid. The window may enable a user to view food items cooking within the grill. Grill housing 110 may include channels and/or grooves disposed adjacent edges of the cooking surface, which may provide tracks along which movable components coupled to a bottom surface of the grill lid are configured to travel. In some examples, the movable components comprise any slidable or rotatable component configured to move within a complementary track, such as wheels, rollers, bearings, and/or the like. In some examples, grill housing 110 and grill lid 112 collectively include one or more drawers disposed on one or both sides of the cooking surface. In some examples, grill lid 112 is pivotable between a horizontal configuration disposed parallel to the cooking surface and a vertical configuration wherein the grill lid is stowed behind the grill housing.

Grill 100 includes a plurality of knobs, buttons, and/or switches 132 disposed within a control panel 130. Knobs 132 enable a user to perform a variety of grill functions, such as vary a temperature level of the grill, light the burners, clean the grill, and/or the like. In some examples, knobs 132 directly control a flow of propane through the burners by opening and closing valves. In some examples, control panel 130 includes one or more controllers 134, which automate certain grill functions. In some examples, rotating knobs 132 instructs controllers 134 to cook food to a certain doneness level or internal temperature. For example, a user may utilize knobs 132 to specify a number of pieces of meat (e.g., steaks) disposed within the grill and to instruct the grill to cook the pieces of meat to a desired doneness (e.g., medium-rare). The controller then automatically adjusts heat and cooking time accordingly.

In some examples, controllers 134 enable a user to utilize an application installed on a remote device (e.g., tablet, smartphone, smart home system) to instruct the grill to carry out a variety of grill functions. The application may enable a user to instruct the grill to cook food to a desired doneness level, without the user interacting with physical control components of the grill. In some examples, the user may utilize the application to instruct the grill to perform an auto clean function (e.g., by setting the grill temperature to a high temperature, such as 800° C.).

In some examples, modular components of the grill have controllers and/or sensors which enable Internet connectivity and/or user control. In some examples, propane compartment 120 includes sensors which enable a user to remotely monitor a propane level of a propane tank and a battery charge level of a battery housed within the propane compartment.

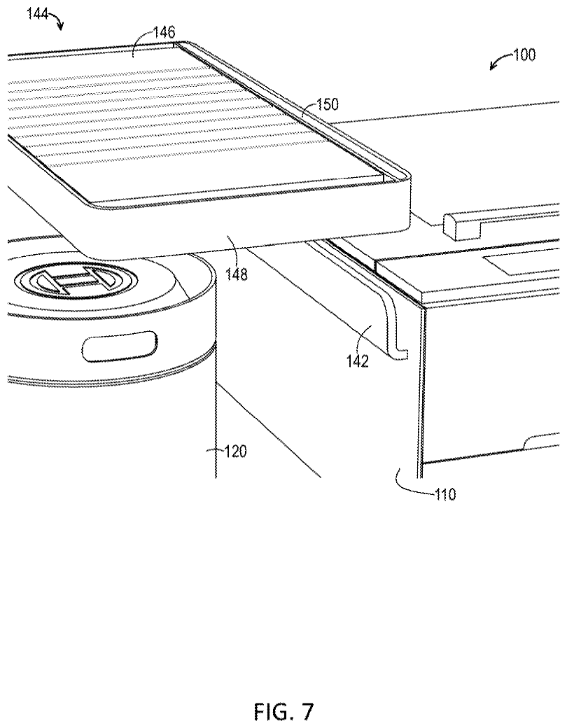

Grill 100 may include a variety of modular components 140 removably connectable to hooks 142 disposed at side portions of the grill housing (see FIGS. 6-7). Hooks 142 each comprise a hooked lip or protrusion extending along a side of the grill cooking surface. In some examples, each hook comprises an elongate, vertically oriented lip connected at a lower edge to the grill housing. As depicted in FIGS. 6 and 7, hooks 142 each include a vertical plate or expanse spaced from the grill and coupled to the grill housing at a lower edge, such that an elongated hook is formed by the plate. Hooks 142 may extend an entire depth (e.g., front to rear) of the grill cooking surface, or any suitable fraction of the grill cooking surface (e.g., ½, ⅓, ¼). Hooks 142 may comprise any suitable rigid material, such as metal (e.g., steel, stainless steel, etc.), coated metal, ceramic, heat-resistant plastics, wood, glass, and/or the like.

In some examples, the modular components include a generally planar work surface (AKA shelf) 144. Planar work surface 144 may comprise a planar sheet or expanse of material 146, and a peripheral hoop or ring 148 disposed around at least a portion of the planar sheet of material. The ring is spaced apart from material 146 at one or more edges of the planar work surface. This defines one or more elongate apertures 150 configured to mate with one or more hooks 142. Coupling planar work surface 144 to hook 142 includes sliding the aperture over one or more vertical lips, such that the planar work surface is supported. Planar work surface 144 may extend along an entire depth of the grill cooking surface, or may extend along any suitable fraction of the grill cooking surface (e.g., ½, ⅓, ¼). Planar work surface 144 may comprise any suitable rigid material, such as wood slats, wood block, metal, granite, linoleum, plastics, and/or the like.

In some examples, the modular components include a supporting ring 152, which is configured to hold one or more storage tubs 154. Ring 152 may comprise a substantially rectangular ring of rigid material, which may further include an internal strut running parallel to one or more edges of the rectangular ring. When present, the internal strut and the ring collectively form an elongate aperture 156 which may receive one or more of hooks 142. Coupling ring 152 to hooks 142 includes sliding the aperture over one or more vertical lips, such that the ring is supported by the vertical lip(s).

Storage tubs 154 may be supported by ring 152, and may include peripheral flanges configured to overlap ring 152. Storage tubs 154 may comprise any suitable material for food storage, such as metal, plastic, glass, and/or the like. In some examples, storage tubs 154 are substantially similar to stainless steel food pans, deli pans, or other standardized restaurant equipment containers.

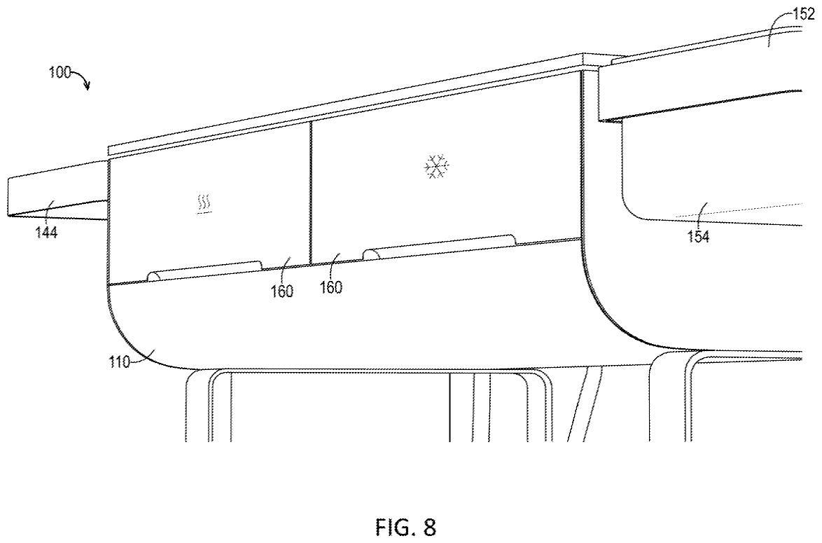

Turning now to FIG. 8, in some examples grill 100 includes one or more temperature-controlled drawers 160 disposed beneath the grill cooking surface. Temperature-controlled drawers 160 may be disposed along a front surface of the grill housing. In some examples, temperature-controlled drawers 160 are disposed within the support base of the grill housing. Temperature-controlled drawers 160 are configured to maintain food at a variety of selected and/or selectable temperatures, and may include a warming drawer, a refrigeration drawer, a freezer drawer, and/or the like. Temperature controlled drawers 160 may be configured to maintain food at any suitable temperature, such as −18° C., 0° C., 4° C., 60° C., and/or the like. Cooling and/or heating systems of the temperature-controlled drawers may be powered by one or more fuel sources coupled to the grill. In some examples, the temperature-controlled drawers are propane-powered. In some examples, the temperature-controlled drawers are powered by an electrical power source, such as battery 124.

### B. Second Illustrative Modular Grill

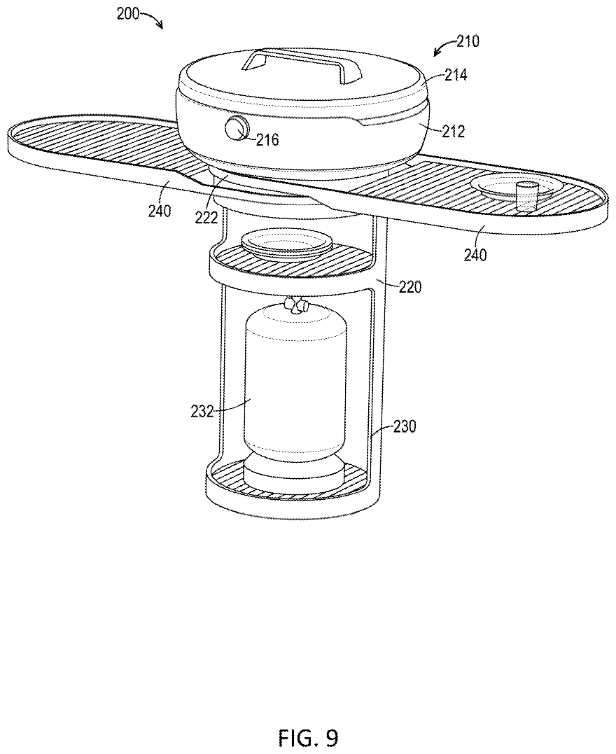

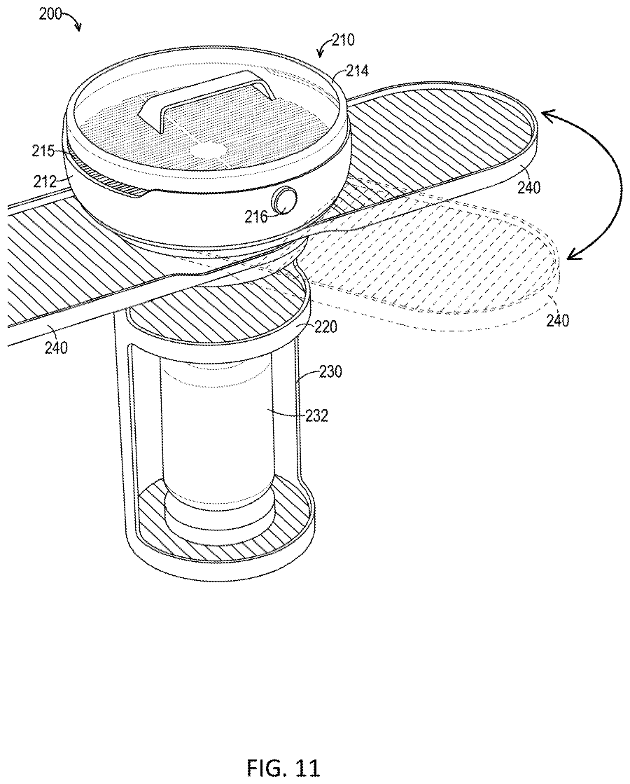

As shown in FIGS. 9-12, this section describes an illustrative modular outdoor grill 200, which includes a portable hibachi grill 210 removably coupled to a grill stand (AKA support base) 220 defining a propane compartment 230, and a plurality of pivotable planar work surfaces 240 coupled to the grill stand. Portable hibachi grill 210 includes a grill housing 212 and a grill lid 214 which collectively enclose one or more burners and a grate 215 defining a cooking surface (AKA grilling surface).

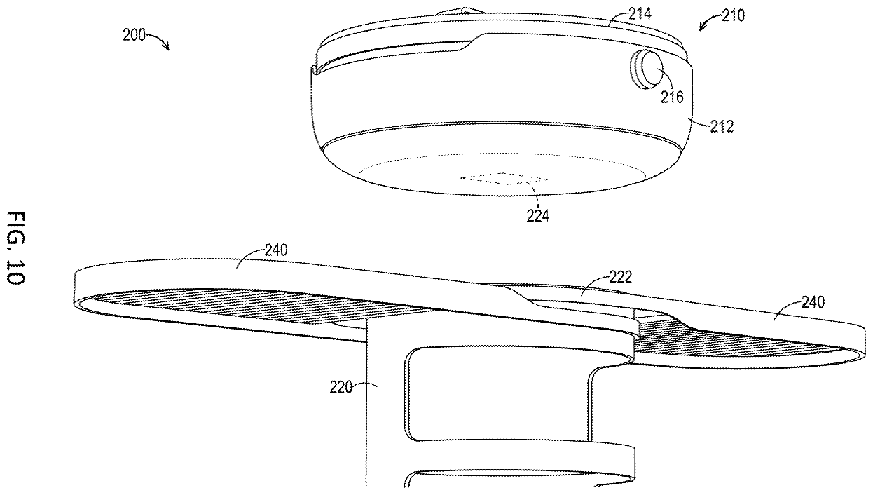

Portable hibachi grill 210 is removably coupled to grill stand 220, but may be removed from grill stand 220 and used in a portable configuration (see FIG. 10). In a coupled configuration, portable hibachi grill 210 rests on and is coupled to a grill interface 222 which includes features 224 configured to couple the hibachi grill to the grill stand. Grill interface 222 defines a top surface of the grill stand. Portable hibachi grill 210 may be mounted and/or locked to the grill stand with a plurality of reversible or removable fasteners, such as clips, pins, hooks, and/or the like. In some examples, portable hibachi grill 210 may be secured to the grill stand using one or more magnets (e.g., electromagnets). A user may utilize an app (e.g., on a mobile digital device) to lock or unlock the portable hibachi grill with respect to the grill stand.

Grill stand 220 includes a housing (e.g., substantially cylindrical) having one or more shelves, at least one of which defines a propane compartment (AKA fuel supply system) 230. A replaceable propane tank 232 is contained within propane compartment 230. A fuel line or hose (not shown) extends between the propane tank and portable hibachi grill 210. In some examples, propane compartment 230 may include a battery and the fuel line may conduct both a flow of propane and electricity (see corresponding description in Section A). In examples wherein portable hibachi grill 210 is separated from the grill stand, a smaller, portable propane tank is utilized to fuel the grill.

One or more planar work surfaces (AKA shelves) 240 are pivotably coupled to grill stand 220 at a top end of the grill stand, e.g., directly beneath grill interface 222. As depicted in the drawings, one or more of the work surfaces are rotatable about a vertical axis of rotation, such that each rotatable work surface can pivot around the grill while remaining in their original plane. In some examples, the vertical axis is disposed within a footprint of the grill housing. In some examples, the vertical axis is disposed at a center (e.g., a geometric center) of the grill housing. Each pivotable planar work surface includes a planar expanse, shelf, or sheet of material, which may, in some examples, include an aperture at a proximal end. The aperture may receive an axial post (e.g., a vertical axle or pin), around which the planar work surface rotates. Planar work surface 240 may comprise any suitable rigid material, such as wood slats, boards, blocks, metal, granite, linoleum, plastics, and/or the like.

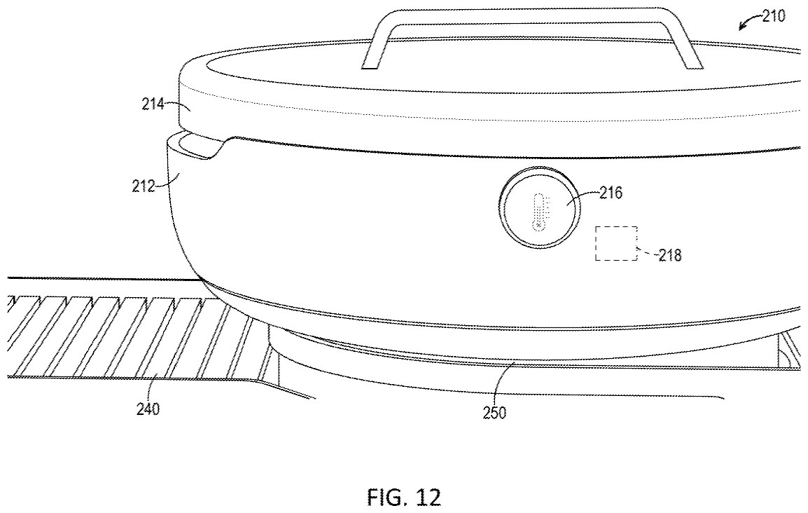

Turning now to FIG. 12, portable hibachi grill 210 includes at least one knob 216 disposed on a front surface of the grill. Knob 216 enables a user to perform a variety of grill functions, such as varying a temperature level of the grill, light burners, cleaning the grill, and/or the like. In some examples, knob 216 directly controls a flow of propane through the burners by opening and closing valves. In some examples, grill 210 includes one or more controllers 218, which automate or partially automate certain grill functions. In some examples, rotating knob 216 instructs controllers 218 to cook food to a certain doneness level or internal temperature. For example, a user may utilize knob 216 to specify a number of pieces of meat (e.g., steaks) disposed within the grill and to instruct the grill to cook the pieces of meat automatically to a desired doneness (e.g., medium-rare).

In some examples, controllers 218 enable a user to utilize a software application installed on a remote device (e.g., tablet, smartphone, smart home system) to instruct the grill to carry out a variety of grill functions. In some examples, the application enables a user to instruct the grill to cook food to a desired doneness level using a remote device, without the user interacting with physical control components of the grill. In some examples, the user utilizes the application to instruct the grill to perform an auto clean function (e.g., by setting the grill temperature to a high temperature, such as 800° C.).

Portable hibachi grill 210 includes one or more lighting features or lights 250 disposed and/or visible on an external surface of the grill. In some examples, lights 250 form a ring of light around a base of the hibachi grill. Lights 250 may illuminate the work surfaces. In some examples, lights 250 are in communication with a temperature sensor disposed within the grill, and are configured to indicate a temperature of an interior of the grill.

### C. Illustrative Data Processing System

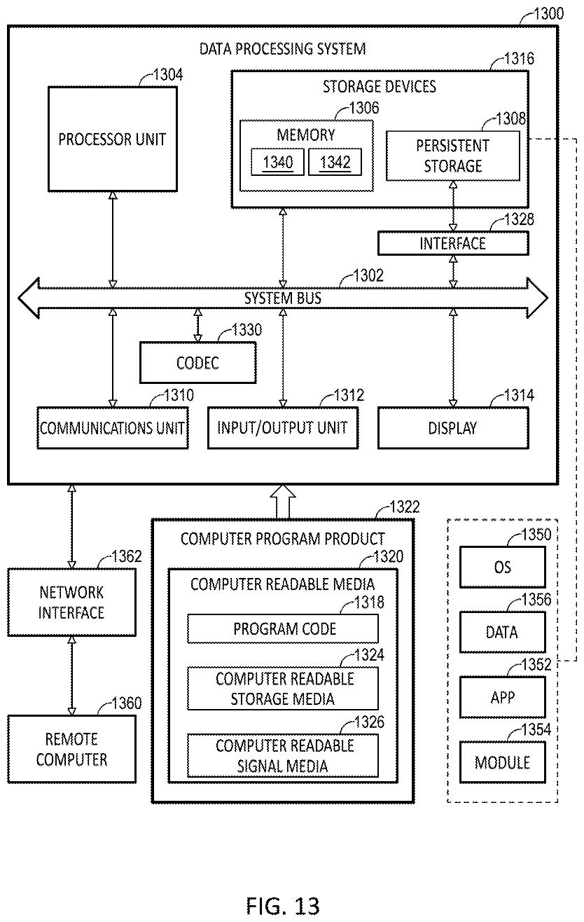

As shown in FIG. 13, this example describes a data processing system 1300 (also referred to as a computer, computing system, and/or computer system) in accordance with aspects of the present disclosure. In this example, data processing system 1300 is an illustrative data processing system suitable for implementing aspects of the modular outdoor grill. More specifically, in some examples, devices that are embodiments of data processing systems (e.g., smartphones, tablets, personal computers) may be utilized as embedded controllers and/or to control remotely certain functions of modular outdoor grills described herein. For example, a user may utilize an application installed on a remote device (e.g., tablet, smartphone, smart home system) to instruct the grill to carry out a variety of grill functions. In some examples, the application may enable a user to instruct the grill to cook food to a desired doneness level using a remote device, and without the user interacting with physical control components of the grill. In some examples, the user may utilize the application to instruct the grill to perform an auto clean function (e.g., by setting the grill temperature to a high temperature, such as 800° C.).

In this illustrative example, data processing system 1300 includes a system bus 1302 (also referred to as communications framework). System bus 1302 may provide communications between a processor unit 1304 (also referred to as a processor or processors), a memory 1306, a persistent storage 1308, a communications unit 1310, an input/output (I/O) unit 1312, a codec 1330, and/or a display 1314. Memory 1306, persistent storage 1308, communications unit 1310, input/output (I/O) unit 1312, display 1314, and codec 1330 are examples of resources that may be accessible by processor unit 1304 via system bus 1302.

Processor unit 1304 serves to run instructions that may be loaded into memory 1306. Processor unit 1304 may comprise a number of processors, a multi-processor core, and/or a particular type of processor or processors (e.g., a central processing unit (CPU), graphics processing unit (GPU), etc.), depending on the particular implementation. Further, processor unit 1304 may be implemented using a number of heterogeneous processor systems in which a main processor is present with secondary processors on a single chip. As another illustrative example, processor unit 1304 may be a symmetric multi-processor system containing multiple processors of the same type.

Memory 1306 and persistent storage 1308 are examples of storage devices 1316. A storage device may include any suitable hardware capable of storing information (e.g., digital information), such as data, program code in functional form, and/or other suitable information, either on a temporary basis or a permanent basis.

Storage devices 1316 also may be referred to as computer-readable storage devices or computer-readable media. Memory 1306 may include a volatile storage memory 1340 and a non-volatile memory 1342. In some examples, a basic input/output system (BIOS), containing the basic routines to transfer information between elements within the data processing system 1300, such as during start-up, may be stored in non-volatile memory 1342. Persistent storage 1308 may take various forms, depending on the particular implementation.

Persistent storage 1308 may contain one or more components or devices. For example, persistent storage 1308 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 1308 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 1308 to system bus 1302, a removable or non-removable interface is typically used, such as interface 1328.

Input/output (I/O) unit 1312 allows for input and output of data with other devices that may be connected to data processing system 1300 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 1304 through system bus 1302 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 1300 and to output information from data processing system 1300 to an output device. One or more output adapters may be provided for certain output devices (e.g., monitors, speakers, and printers, among others) which require special adapters. Suitable output adapters may include, e.g. video and sound cards that provide a means of connection between the output device and system bus 1302. Other devices and/or systems of devices may provide both input and output capabilities, such as remote computer(s) 1360. Display 1314 may include any suitable human-machine interface or other mechanism configured to display information to a user, e.g., a CRT, LED, or LCD monitor or screen, etc.

Communications unit 1310 refers to any suitable hardware and/or software employed to provide for communications with other data processing systems or devices. While communication unit 1310 is shown inside data processing system 1300, it may in some examples be at least partially external to data processing system 1300. Communications unit 1310 may include internal and external technologies, e.g., modems (including regular telephone grade modems, cable modems, and DSL modems), ISDN adapters, and/or wired and wireless Ethernet cards, hubs, routers, etc. Data processing system 1300 may operate in a networked environment, using logical connections to one or more remote computers 1360. A remote computer(s) 1360 may include a personal computer (PC), a server, a router, a network PC, a workstation, a microprocessor-based appliance, a peer device, a smart phone, a tablet, another network note, and/or the like. Remote computer(s) 1360 typically include many of the elements described relative to data processing system 1300. Remote computer(s) 1360 may be logically connected to data processing system 1300 through a network interface 1362 which is connected to data processing system 1300 via communications unit 1310. Network interface 1362 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 1330 may include an encoder, a decoder, or both, comprising hardware, software, or a combination of hardware and software. Codec 1330 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 1330 is depicted as a separate component, codec 1330 may be contained or implemented in memory, e.g., non-volatile memory 1342.

Non-volatile memory 1342 may include read only memory (ROM), programmable ROM (PROM), electrically programmable ROM (EPROM), electrically erasable programmable ROM (EEPROM), flash memory, and/or the like, or any combination of these. Volatile memory 1340 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 1316, which are in communication with processor unit 1304 through system bus 1302. In these illustrative examples, the instructions are in a functional form in persistent storage 1308. These instructions may be loaded into memory 1306 for execution by processor unit 1304. Processes of one or more embodiments of the present disclosure may be performed by processor unit 1304 using computer-implemented instructions, which may be located in a memory, such as memory 1306.

These instructions are referred to as program instructions, program code, computer usable program code, or computer-readable program code executed by a processor in processor unit 1304. The program code in the different embodiments may be embodied on different physical or computer-readable storage media, such as memory 1306 or persistent storage 1308. Program code 1318 may be located in a functional form on computer-readable media 1320 that is selectively removable and may be loaded onto or transferred to data processing system 1300 for execution by processor unit 1304. Program code 1318 and computer-readable media 1320 form computer program product 1322 in these examples. In one example, computer-readable media 1320 may comprise computer-readable storage media 1324 or computer-readable signal media 1326.

Computer-readable storage media 1324 may include, for example, an optical or magnetic disk that is inserted or placed into a drive or other device that is part of persistent storage 1308 for transfer onto a storage device, such as a hard drive, that is part of persistent storage 1308. Computer-readable storage media 1324 also may take the form of a persistent storage, such as a hard drive, a thumb drive, or a flash memory, that is connected to data processing system 1300. In some instances, computer-readable storage media 1324 may not be removable from data processing system 1300.

In these examples, computer-readable storage media 1324 is a non-transitory, physical or tangible storage device used to store program code 1318 rather than a medium that propagates or transmits program code 1318. Computer-readable storage media 1324 is also referred to as a computer-readable tangible storage device or a computer-readable physical storage device. In other words, computer-readable storage media 1324 is media that can be touched by a person.

Alternatively, program code 1318 may be transferred to data processing system 1300, e.g., remotely over a network, using computer-readable signal media 1326. Computer-readable signal media 1326 may be, for example, a propagated data signal containing program code 1318. For example, computer-readable signal media 1326 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1318 may be downloaded over a network to persistent storage 1308 from another device or data processing system through computer-readable signal media 1326 for use within data processing system 1300. For instance, program code stored in a computer-readable storage medium in a server data processing system may be downloaded over a network from the server to data processing system 1300. The computer providing program code 1318 may be a server computer, a client computer, or some other device capable of storing and transmitting program code 1318.

In some examples, program code 1318 may comprise an operating system (OS) 1350. Operating system 1350, which may be stored on persistent storage 1308, controls and allocates resources of data processing system 1300. One or more applications 1352 take advantage of the operating system's management of resources via program modules 1354, and program data 1356 stored on storage devices 1316. OS 1350 may include any suitable software system configured to manage and expose hardware resources of computer 1300 for sharing and use by applications 1352. In some examples, OS 1350 provides application programming interfaces (APIs) that facilitate connection of different type of hardware and/or provide applications 1352 access to hardware and OS services. In some examples, certain applications 1352 may provide further services for use by other applications 1352, e.g., as is the case with so-called “middleware.” Aspects of present disclosure may be implemented with respect to various operating systems or combinations of operating systems.

The different components illustrated for data processing system 1300 are not meant to provide architectural limitations to the manner in which different embodiments may be implemented. One or more embodiments of the present disclosure may be implemented in a data processing system that includes fewer components or includes components in addition to and/or in place of those illustrated for computer 1300. Other components shown in FIG. 13 can be varied from the examples depicted. Different embodiments may be implemented using any hardware device or system capable of running program code. As one example, data processing system 1300 may include organic components integrated with inorganic components and/or may be comprised entirely of organic components (excluding a human being). For example, a storage device may be comprised of an organic semiconductor.

In some examples, processor unit 1304 may take the form of a hardware unit having hardware circuits that are specifically manufactured or configured for a particular use, or to produce a particular outcome or progress. This type of hardware may perform operations without needing program code 1318 to be loaded into a memory from a storage device to be configured to perform the operations. For example, processor unit 1304 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 1318) may be implemented as hardware, e.g., by specifying an FPGA configuration using a hardware description language (HDL) and then using a resulting binary file to (re)configure the FPGA.

In another example, data processing system 1300 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 1304 may be implemented using a combination of processors found in computers and hardware units. Processor unit 1304 may have a number of hardware units and a number of processors that are configured to run program code 1318. With this depicted example, some of the processes may be implemented in the number of hardware units, while other processes may be implemented in the number of processors.

In another example, system bus 1302 may comprise one or more buses, such as a system bus or an input/output bus. Of course, the bus system may be implemented using any suitable type of architecture that provides for a transfer of data between different components or devices attached to the bus system. System bus 1302 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 1310 may include a number of devices that transmit data, receive data, or both transmit and receive data. Communications unit 1310 may be, for example, a modem or a network adapter, two network adapters, or some combination thereof. Further, a memory may be, for example, memory 1306, or a cache, such as that found in an interface and memory controller hub that may be present in system bus 1302.

### D. Illustrative Distributed Data Processing System

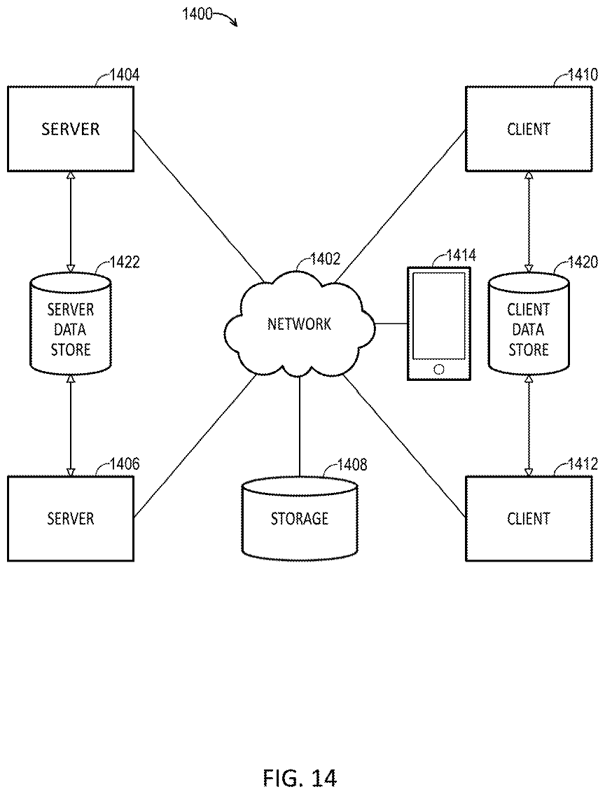

As shown in FIG. 14, this example describes a general network data processing system 1400, interchangeably termed a computer network, a network system, a distributed data processing system, or a distributed network, aspects of which may be included in one or more illustrative embodiments of modular outdoor grills. For example, modular outdoor grills described herein may communicate with a user's portable electronic devices over a network to alert a user to a grill status. Additionally, a user may utilize a portable electronic device to instruct the grill over a network to perform certain grill functions, such as changing a grill temperature, cooking a food item to a certain doneness level, cleaning the grill, and/or the like. In some examples, modular outdoor grills described herein are components of a smart home system, and may communicate with other appliances over a network to collaboratively execute a recipe.

It should be appreciated that FIG. 14 is provided as an illustration of one implementation and is not intended to imply any limitation with regard to environments in which different embodiments may be implemented. Many modifications to the depicted environment may be made.

Network system 1400 is a network of devices (e.g., computers), each of which may be an example of data processing system 1300, and other components. Network data processing system 1400 may include network 1402, which is a medium configured to provide communications links between various devices and computers connected within network data processing system 1400. Network 1402 may include connections such as wired or wireless communication links, fiber optic cables, and/or any other suitable medium for transmitting and/or communicating data between network devices, or any combination thereof.

In the depicted example, a first network device 1404 and a second network device 1406 connect to network 1402, as do one or more computer-readable memories or storage devices 1408. Network devices 1404 and 1406 are each examples of data processing system 1300, described above. In the depicted example, devices 1404 and 1406 are shown as server computers, which are in communication with one or more server data store(s) 1422 that may be employed to store information local to server computers 1404 and 1406, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 1410 and 1412 and/or a client smart device 1414, may connect to network 1402. Each of these devices is an example of data processing system 1300, described above regarding FIG. 13. Client electronic devices 1410, 1412, and 1414 may include, for example, one or more personal computers, network computers, and/or mobile computing devices such as personal digital assistants (PDAs), smart phones, handheld gaming devices, wearable devices, and/or tablet computers, and the like. In the depicted example, server 1404 provides information, such as boot files, operating system images, and applications to one or more of client electronic devices 1410, 1412, and 1414. Client electronic devices 1410, 1412, and 1414 may be referred to as “clients” in the context of their relationship to a server such as server computer 1404. Client devices may be in communication with one or more client data store(s) 1420, which may be employed to store information local to the clients (e,g., cookie(s) and/or associated contextual information). Network data processing system 1400 may include more or fewer servers and/or clients (or no servers or clients), as well as other devices not shown.

In some examples, first client electric device 1410 may transfer an encoded file to server 1404. Server 1404 can store the file, decode the file, and/or transmit the file to second client electric device 1412. In some examples, first client electric device 1410 may transfer an uncompressed file to server 1404 and server 1404 may compress the file. In some examples, server 1404 may encode text, audio, and/or video information, and transmit the information via network 1402 to one or more clients.

Client smart device 1414 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 1400 may be stored in or on a computer-readable storage medium, such as network-connected storage device 1408 and/or a persistent storage 1308 of one of the network computers, as described above, and may be downloaded to a data processing system or other device for use. For example, program code may be stored on a computer-readable storage medium on server computer 1404 and downloaded to client 1410 over network 1402, for use on client 1410. In some examples, client data store 1420 and server data store 1422 reside on one or more storage devices 1408 and/or 1308.

Network data processing system 1400 may be implemented as one or more of different types of networks. For example, system 1400 may include an intranet, a local area network (LAN), a wide area network (WAN), or a personal area network (PAN). In some examples, network data processing system 1400 includes the Internet, with network 1402 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 1402 may be referred to as a “cloud.” In those examples, each server 1404 may be referred to as a cloud computing node, and client electronic devices may be referred to as cloud consumers, or the like. FIG. 14 is intended as an example, and not as an architectural limitation for any illustrative embodiments.

### E. Illustrative Combinations and Additional Examples

This section describes additional aspects and features of modular outdoor grills, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. An outdoor grill, comprising:

a grilling surface disposed above a burner in a grill housing;

a fuel supply system coupled to the burner and configured to convey fuel to the burner from a replaceable fuel tank;

a support base coupled to the grill housing and structurally supporting the grill housing at a working height; and

a shelf having a peripheral hoop extending at least partly around the shelf, such that the hoop is removably coupled to a hook adjacent the grilling surface, wherein the hook comprises an elongate, vertically oriented lip, such that the shelf is configured to be selectively attached and detached from the grill.

A1. The grill of paragraph A0, wherein the lip of the hook is connected at a lower edge to the grill housing.

A2. The grill of paragraph A0 or A1, further comprising a housing configured to enclose the replaceable fuel tank.

A3. The grill of any of paragraphs A0 through A2, further comprising a rechargeable battery configured to power one or more electrical features of the grill.

A4. The grill of any of paragraphs A0 through A3, wherein the battery and the replaceable fuel tank are housed in a common enclosure.

A5. The grill of paragraph A4, wherein power from the battery and fuel from the fuel tank are carried to the grill housing by a combined fuel line and power cable.

A6. The grill of any of paragraphs A0 through A5, further comprising a temperature-controlled drawer disposed in the support base.

A7. The grill of paragraph A6, wherein a cooling device of the temperature-controlled drawer is powered by fuel from the replaceable fuel tank.

A8. The grill of any of paragraphs A0 through A7, wherein the fuel is propane.

A9. The grill of any of paragraphs A0 through A8, wherein the grill housing is selectively removable from the support base.

B0. An outdoor grill, comprising:

a grilling surface disposed above a burner in a grill housing;

a fuel supply system coupled to the burner and configured to convey fuel to the burner from a replaceable fuel tank;

a support base coupled to the grill housing and structurally supporting the grill housing at a working height; and

a shelf pivotably coupled to the grill such that the shelf is pivotable about a vertical axis between a plurality of positions relative to the grill housing.

B1. The grill of paragraph B0, wherein the vertical axis is disposed within a footprint of the grill housing.

B2. The grill of paragraph B1, wherein the vertical axis is disposed at a center of the grill housing.

B3. The grill of any of paragraphs B0 through B2, further comprising a housing configured to enclose the replaceable fuel tank.

B4. The grill of any of paragraphs B0 through B3, further comprising a rechargeable battery configured to power one or more electrical features of the grill.

B5. The grill of paragraph B4, wherein the battery and the replaceable fuel tank are housed in a common enclosure.

B6. The grill of paragraph B4, wherein power from the battery and fuel from the fuel tank are carried to the grill housing by a combined fuel line and power cable.

B7. The grill of any of paragraphs B0 through B6, further comprising a temperature-controlled drawer disposed in the support base.

B8. The grill of paragraph B7, wherein a cooling device of the temperature-controlled drawer is powered by fuel from the replaceable fuel tank.

B9. The grill of any of paragraphs B0 through B8, wherein the grill housing is selectively removable from the support base.

### Advantages, Features, and Benefits

The different embodiments and examples of the modular outdoor grill described herein provide several advantages over known outdoor cooking systems. For example, illustrative embodiments and examples described herein allow a user to utilize easily available power sources to provide electrical power to an outdoor grill.

Additionally, and among other benefits, illustrative embodiments and examples described herein provide an easy and safe connection of gas power and electrical power.

Additionally, and among other benefits, illustrative embodiments and examples described herein allow a user to check their battery and gas status from anywhere.

Additionally, and among other benefits, illustrative embodiments and examples described herein allow a user to have easy and fast access to their food.

Additionally, and among other benefits, illustrative embodiments and examples described herein will cook food to a desired doneness level and inform a user when food is ready.

Additionally, and among other benefits, illustrative embodiments and examples described herein will enable a user to personalize their cooking area.

Additionally, and among other benefits, illustrative embodiments and examples described herein keep raw food cool and grilled food warm.

Additionally, and among other benefits, illustrative embodiments and examples described herein allow a user to take their portable grill with them wherever they would like to grill.

Additionally, and among other benefits, illustrative embodiments and examples described herein allow a grill to fit in any setting.

Additionally, and among other benefits, illustrative embodiments and examples described herein help the user throughout the cooking process.

Additionally, and among other benefits, illustrative embodiments and examples described herein clean the grill and allow a user to track the pyrolitic cleaning process.

Additionally, and among other benefits, illustrative embodiments and examples described herein give the user a visual indication of the grill status and light up working areas.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An outdoor grill, comprising:
a grilling surface disposed above a burner in a grill housing;
a fuel supply system coupled to the burner and configured to convey fuel to the burner from a replaceable fuel tank;
a support base coupled to the grill housing and structurally supporting the grill housing at a working height; and
a shelf having a peripheral hoop extending at least partly around the shelf, such that the hoop is removably coupled to a hook adjacent the grilling surface, wherein the hook comprises an elongate, vertically oriented lip, such that the shelf is configured to be selectively attached and detached from the grill.

2. The grill of claim 1, wherein the lip of the hook is connected at a lower edge to the grill housing.

3. The grill of claim 1, further comprising a housing configured to enclose the replaceable fuel tank.

4. The grill of claim 1, further comprising a rechargeable battery configured to power one or more electrical features of the grill.

5. The grill of claim 4, wherein the battery and the replaceable fuel tank are housed in a common enclosure.

6. The grill of claim 4, wherein power from the battery and fuel from the fuel tank are carried to the grill housing by a combined fuel line and power cable.

7. The grill of claim 1, further comprising a temperature-controlled drawer disposed in the support base.

8. The grill of claim 7, wherein a cooling device of the temperature-controlled drawer is powered by fuel from the replaceable fuel tank.

9. The grill of claim 1, wherein the fuel is propane.

10. The grill of claim 1, wherein the grill housing is selectively removable from the support base.

11. An outdoor grill, comprising:
a grilling surface disposed above a burner in a grill housing;
a fuel supply system coupled to the burner and configured to convey fuel to the burner from a replaceable fuel tank;
a support base coupled to the grill housing and structurally supporting the grill housing at a working height; and
a shelf pivotably coupled to the grill such that the shelf is pivotable about a vertical axis between a plurality of positions relative to the grill housing.

12. The grill of claim 11, wherein the vertical axis is disposed within a footprint of the grill housing.

13. The grill of claim 12, wherein the vertical axis is disposed at a center of the grill housing.

14. The grill of claim 12, further comprising a housing configured to enclose the replaceable fuel tank.

15. The grill of claim 11, further comprising a rechargeable battery configured to power one or more electrical features of the grill.

16. The grill of claim 15, wherein the battery and the replaceable fuel tank are housed in a common enclosure.

17. The grill of claim 15, wherein power from the battery and fuel from the fuel tank are carried to the grill housing by a combined fuel line and power cable.

18. The grill of claim 11, further comprising a temperature-controlled drawer disposed in the support base.

19. The grill of claim 18, wherein a cooling device of the temperature-controlled drawer is powered by fuel from the replaceable fuel tank.

20. The grill of claim 11, wherein the grill housing is selectively removable from the support base.
